(19) United States
(12) Patent Application Publication
(10) Pub. No.: US 2017/0368707 A1
(43) Pub. Date: Dec. 28, 2017

(54) INTEGRALLY BONDED GRIPPER

(71) Applicant: GEA Food Solution Germany GmbH, Biedenkopf-Wallau (DE)

(72) Inventor: Markus Keller, Pflach (AT)

(21) Appl. No.: 15/525,663

(22) PCT Filed: Nov. 3, 2015
(86) PCT No.: PCT/EP2015/075580

§ 371 Date: May 10, 2017

(30) Foreign Application Priority Data
Nov. 25, 2014 (DE) 10 2014 224 005.0

(51) Int. Cl. B26D 7/01; B25J 15/02; B25J 15/00; B25J 5/00; B65G 47/90; B26D 1/36

(52) U.S. Cl. CPC B26D 7/01; B65G 47/905; B26D 1/36; B25J 15/0095; B25J 5/005; B25J 15/0273; B26D 2007/011; B26D 2210/02

(57) ABSTRACT

The invention relates to a gripper for use in a slicing machine, in particular a high-performance slicing machine, said gripper being joined to the food product using an integral bonding process.

The present invention relates to a gripper for use in a cutting machine, in particular a high-performance cutting machine, which gripper can reversibly be brought into engagement with one end of a food product.

Such grippers are known from the prior art, for instance from EP 2 095 918, EP 2 095 920 and EP 2 095 919, are used in high-performance cutting machines in which food product, for example meat, sausage and/or cheese blocks, are cut into food slices. Before or during the slicing of the food product, the gripper is brought into engagement with the end of said food product in order, for instance, to guide, to stabilize this end piece during the slicing process, and/or in order to dispose of an end piece which cannot be further sliced or is not intended to be sliced. The grippers according to the prior art have the drawback, however, that the food product is compressed during the gripping process, and/or that there remains a comparatively large remnant which can no longer be reprocessed, into saleable food portions.

The object of the present invention was therefore to provide a gripper which does not have the drawbacks of the prior art.

The object is achieved with a gripper for use in a cutting machine, in particular a high-performance cutting machine, which gripper, before and/or during the slicing of a food product, is at least periodically, and reversibly, engaged with the end of the food product, wherein the gripper is connected in an integrally bonded manner to the end of the food product.

The statements made with respect to this subject of the present invention apply equally to the other subjects of the present invention, and vice versa.

The present invention relates to a gripper for use in cutting machines, in particular a high-performance cutting machine, in which food products are cut into food slices. This gripper is reversibly engaged with a food product, for instance with one end thereof, and fixes and/or guides this same, in particular during the slicing of the last food slices of the food product. Furthermore, the gripper holds the remnant and guides it, for instance, over a disposal shaft, where it is released from the gripper and falls into a disposal shaft.

Preferably, the gripper has one or more contact surfaces, against which the food product bears. Preferably, the shape of the respective contact surface, at least in some sections, is matched to the shape of the food product against which the gripper bears.

Preferably, the gripper, in particular the part which is connected in an integrally bonded manner to the food product, is provided from a material having a low thermal capacity, so that this part can be rapidly cooled and rapidly warmed. For instance, this part is produced from plastic and/or aluminum.

According to the invention, this gripper is now connected in an integrally bonded manner to the food product, in particular to the rear end thereof, wherein the material bond is preferably provided such that it is reversible. The material bond between the gripper and the food product is realized before and/or during the slicing of the food product, wherein, in order to save time, at least the completion of the material bond is preferred to be realized once a cut has already taken place. Following the slicing, the material bond is broken and/or the remaining remnant is mechanically released from the gripper, for instance with an ejector.

Preferably, the material bond is realized by a phase change of a bonding substance, in particular water, which is provided between the gripper and the food product. This bonding substance is provided in the liquid and/or pasty state between the gripper, in particular the contact surface(s) thereof, and hardens there. The material bond between the gripper and the food product is thereby formed. The bonding substance can be brought between the gripper and the food product by spraying, condensation/separation, brushing and/or atomization. For instance, liquid water is applied to the gripper and/or the food product and freezes there, so that an integrally bonded joint between the gripper and the food product materializes. As the bonding agent, an adhesive which is approved for use under food legislation, and/or gelatin, is also suitable, however.

Preferably, a means for providing the bonding substance between the gripper and the food product is provided on the slicing device, in particular the gripper.

The food product, for instance sausage, cheese or ham, can be frozen or have a temperature>0° C. during the slicing process.

According to a preferred embodiment, the gripper and/or the food product is/are provided so as to be coolable. This cooling facility can be connected, for instance, directly or indirectly, to the gripper/food product. The energy transfer between the cold source and the gripper/product can be realized by radiation, conductance and/or convection. The cooling induces the phase change of the bonding substance, in this case from gaseous and/or liquid to solid. The gripper thereby joins in an integrally bonded manner to the food product to be sliced.

Preferably, the cooling is realized by a liquid gas, in particular liquid nitrogen.

It is also possible, however, that in particular the food product and/or, where appropriate, the gripper, is/are sufficiently cold that, when the bonding substance is touched by at least one of the two parts to be bonded, it hardens and produces the integrally bonded joint between the gripper and the food product.

According to a preferred embodiment, the gripper and/or the food product is/are provided so as to be warmable. This warming facility can be connected, for instance, directly or indirectly, to the gripper/food product. The heat transfer between the heat source and the gripper/product can be realized by radiation, conductance and/or convection. The warming induces the phase change of the bonding substance, in this case from solid to liquid and/or gaseous. As a result, the remnant detaches itself from the gripper. Preferably, the heating facility is an electric heater, in particular having a very low thermal capacity and a very short response time, in particular in the millisecond range. For instance, the heating can be realized by IR and/or NIR radiation, in particular with a carbon emitter.

Preferably, the gripper additionally has a positive locking and/or non-positive locking means, preferably a claw, a cutter and/or a spike. This means can also serve to enlarge the contact area between the gripper and the food product and to thereby improve the material bond.

The gripper according to the invention has the advantage that only a very small remnant cannot be sliced, whereby the number of cut-off food slices per food product is increased. Given the material bond between the gripper and the food product, no, or only very small forces are exerted on the food product, so that the shape thereof does not change, which in particular in the case of scanned products which are to be sliced to an exact weight, is very advantageous.

A further subject of the present invention is a slicing device having at least one gripper according to the invention.

The statements made with respect to this subject of the present invention apply equally to the other subjects of the present invention, and vice versa.

Preferably, the slicing device has a plurality of tracks, i.e. at least periodically a plurality of food products are sliced simultaneously, side by side. In this case, each track preferably has a gripper, which respectively grips a food product, in particular the end thereof. The grippers are preferably individually drivable, so that the food products in the individual tracks can be sliced at different speeds.

A further subject of the present invention is a method for slicing a food product, in which the end of the food product, before and/or during the slicing, is brought into contact with a gripper, and in which a material bond is formed between the end of the food product and the gripper.

The statements made with respect to this subject of the present invention apply equally to the other subjects of the present invention, and vice versa.

According to the invention, before and/or during the cutting of the food product into food slices, the gripper is connected in an integrally bonded manner to the food product, in particular the end thereof. For this, the gripper is moved, for instance, in the direction of the rear end of the food product. Before and/or during this movement and/or while the gripper is already bearing against the food product, a bonding agent is provided between the food product and the gripper, which bonding agent then solidifies there and produces the material bond. As soon as the cutting of the food product is ended, the remnant remaining from the food product is released again from the gripper. This can be realized by a warming of the gripper and/or of the remnant, and/or in that the remnant is separated from the gripper with a mechanical force which surpasses the force of the material bond. After this, the gripper is brought back into its starting position and herein, and/or subsequently, prepared again for the material bond with the next food product, for instance in that the gripper as a whole, and/or the contact surfaces thereof, is/are, in particular, cooled again.

Preferably, the end of the food product is frozen to the gripper. The water needed for this and/or the moisture needed for this can be applied to the gripper, in particular the contact surfaces thereof, and/or to the food product, for instance by condensation/separation, spraying, atomization, coating, immersion. In the case of frozen food products, the end can, however, also be briefly thawed, so that moisture which is on the surface thereof thaws and then, upon contact with the gripper, solidifies again and thereby produces the material bond between gripper and food product.

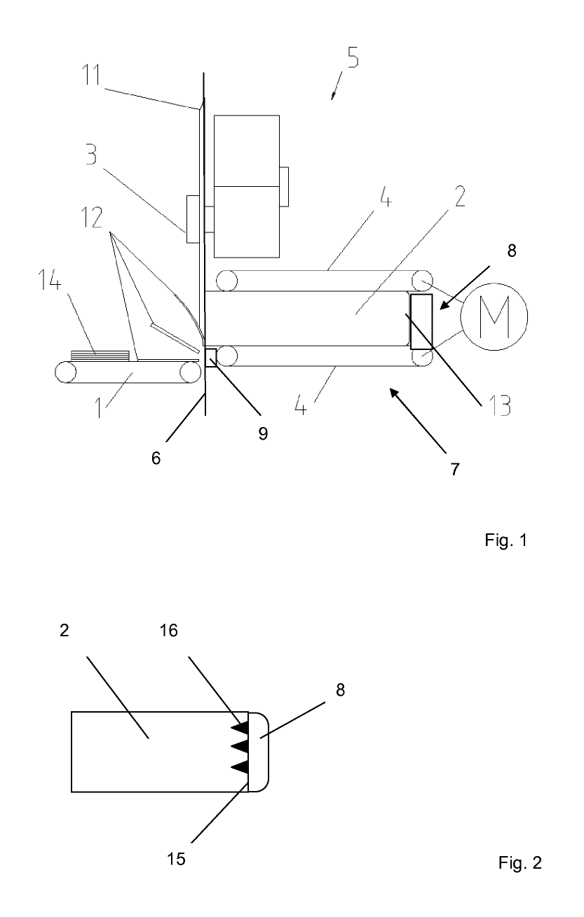

Below, the invention is explained with reference to FIGS. 1 and 2. These elucidations are merely illustrative and do not restrict the general inventive concept. The statements apply equally to all subjects of the present invention.

FIG. 1 shows the slicing device according to the invention,

FIG. 2 shows the slicing device according to the invention and the method according to the invention.

FIG. 1 shows a slicing device 5. The slicing device 5 has a cutting blade 11, which cuts a food product 2 into food slices 12. To this end, each food product 2 is transported with a conveying means 4, in this case two conveyor belts 4, continuously or intermittently in the direction of the cutting plane 6 of the blade 11. The lower conveyor belt 4 is at the same time a product support. The cutting blade 11 is fastened to a rotating blade holder 3 and cooperates for cutting purposes with a cutting edge 9 provided, for instance, on the front end of a product support 4, which jointly define the cutting plane 6. Present between the blade 11 and the cutting edge 9 is a so-called blade clearance, which should be as small as possible, yet must be sufficiently large that the blade does not touch the cutting edge. This clearance must be regularly adjusted. This can be realized by a movement of the blade and/or of the cutting edge. Moreover, the cutting edge must be oriented parallel to the blade. Following the separation, the food slices fall generally onto a delivery table 1, which is provided with transporting means, for instance a conveyor or conveyor belt, on which they are configured to respectively form a portion 14, in this case a stack. The finished portions 14 are next transported out of the cutting blade region and subsequently packed. The slice thickness derives from the feed distance of the food product between two cuts. Given constant blade rotation speed, the slice thickness is regulated via the feed rate of the food product. The slicing device has for each feed line 7 a gripper 8, which grips the rear end 13 of the food product 2 before and/or during the slicing and stabilizes this during the slicing, in particular toward the end of the slicing, and disposes of the end piece which cannot be sliced. Each gripper is preferably provided on a gripper carriage (not represented), which moves the grippers back and forth, in particular parallel to the direction of feed of the food product. Each gripper is preferably, at least periodically, individually drivable.

Preferably, the slicing device is provided in multitrack form, i.e. a plurality of food products 2 are sliced by a blade, in particular at least periodically simultaneously or at least periodically sequentially. For this, the device has for each food product a dedicated track 7, along which it is transported in the direction of the blade 11.

According to the invention, the gripper is connected in an integrally bonded manner to the food product. This material bond is preferably realized by solidification/freezing of water or moisture, present between the gripper and the food product, before and/or after the gripper has been led up to the food product and/or brought into contact with this same. Preferably, the slicing device according to the invention and/or the gripper according to the invention has/have a cooling device and/or a heating device, which cause the water or moisture to solidify and thaw or unfreeze again.

FIG. 2 shows a preferred embodiment of the gripper according to the invention. In the present case, this has claws, hooks and/or cutters 16, which, in addition to the material bond, can also produce a form closure and/or force closure. However, the means 16 can also serve merely to enlarge the contact area between the gripper and the food product 2 in order to improve the material bond.

### REFERENCE SYMBOL LIST

1 delivery table

2 food product

3 blade holder

4 support surface, transport means of a track 7

5 slicing device

6 cutting plane

7 track

8 gripper

9 cutter bar, cutting edge

10 product guide

11 blade, cutting blade, circular blade, sickle-shaped blade

12 food slices

13 rear side of the food product

14 portion, food portion

15 integrally bonded joint between gripper and product

16 integrally bonded, positive locking and/or non-positive locking joint between the gripper and the product

1. A high-performance cutting machine comprising:
a cutting blade that separates food slides from an end of a food product; and
a gripper that is reversibly engaged with an opposing end of the food product, the gripper is configured to fix and/or guide the food product during slicing of a last food slice from the food product,
wherein the gripper is connected in an integrally bonded manner to the opposing end of the food product.

2. The cutting machine as claimed in claim 1, wherein the bond is realized by a phase change of a bonding substance.

3. The cutting machine as claimed in claim 2, wherein the gripper and/or the food product is/are provided so as to be coolable.

4. The cutting machine as claimed in claim 3, wherein the cooling is realized by a liquid gas.

5. The cutting machine as claimed in claim 2, wherein the gripper and/or the food product is/are provided so as to be warmable.

6. The cutting machine as claimed in claim 5, wherein the gripper and/or the food product is/are warmed with a heating facility that is an electric heater.

7. The cutting machine as claimed in claim 1, wherein the cutting machine comprises a positive locking and/or non-positive locking means.

8. A method for slicing a food product with a high performance cutting machine that comprises a cutting blade and a gripper, the method comprising steps of:
separating food slides from an end of the food product with the cutting blade, and
reversibly engaging an opposing end of the food product with the gripper, the gripper fixes and/or guides the food product during slicing of a last slice of the food product, and
forming a material bond between the end of the food product and the gripper.

9. The method as claimed in claim 8, wherein the forming step comprises freezing the end of the food product to the gripper.

10. The method as claimed in claim 8, wherein, following conclusion of the slicing, the method comprises a step of breaking a joint.

11. The cutting machine as claimed in claim 2, wherein the bonding substance is water that is located between the gripper and the food product.

12. The cutting machine as claimed in claim 2, wherein the bonding substance is water that is sprayed, brushed, coated, immersed, and/or condensation located between the end of the food product and the gripper.

13. The cutting machine as claimed in claim 4, wherein the liquid gas is nitrogen.

14. The cutting machine as claimed in claim 7, wherein the positive locking and/or non-positive locking means comprises a claw and/or a spike.

15. The cutting machine as claimed in claim 1, wherein the bond between the gripper and the opposing end of the food product is completed after a cut from the end of the food product has already taken place.

16. The method as claimed in claim 10, wherein the joint is broken by a step of unfreezing.

17. The method as claimed in claim 8, wherein the method comprises a step of completing the material bond between the end of the food product and the gripper after a food slice has been separated from the end of the food product.

18. The method as claimed in claim 9, wherein before the forming step, the method comprises a step of: spraying, condensation/separation, brushing and/or atomization of a bonding substance between the end of the food product and the gripper,
wherein the freezing step comprising freezing the bonding substance to form the material bond between the end of the food product and the gripper.

19. A cutting machine comprising:
a cutting blade that separates food slides from an end of a food product; and
a gripper that is bonded to an opposing end of the food product before and during slicing of the food product,
wherein the bond is achieved by solidifying or freezing a liquid present between the gripper and the opposing end of the food product,
wherein the liquid is sprayed, brushed, coated, immersed, and/or condensation located between the end of the food product and the gripper,
wherein the freezing of the liquid is realized with liquid nitrogen,
wherein after the food slices are separated from the end of the food product, the bond is broken by warming the gripper, the food product, or both, and
wherein the piper comprises a claw, a hook, and/or a cutter that engage the opposing end of the food product in addition to the bond.

20. The cutting machine as claimed is claim 19, wherein the bond between the gripper and the opposing end of the food product is completed after a cut from the end of the food product has already taken place.
